(19) United States
(12) Patent Application Publication
(10) Pub. No.: US 2026/0192789 A1
(43) Pub. Date: Jul. 9, 2026

(54) BRAKING SYSTEM

(71) Applicant: Schaeffler Technologies AG & Co. KG, Herzogenaurach (DE)

(72) Inventors: Benedikt Grubauer, Neresheim (DE); Simon Ortmann, Pulheim (DE)

(21) Appl. No.: 19/133,558

(22) PCT Filed: Nov. 8, 2023
(86) PCT No.: PCT/DE2023/100832

§ 371 Date: May 28, 2025

(30) Foreign Application Priority Data
Nov. 28, 2022 (DE) 10 2022 131 384.0

(51) Int. Cl. B60T 13/74; B60T 1/06; F16D 55/38; F16D 65/18; F16D 65/853; F16D 121/24; F16D 125/40

(52) U.S. Cl. CPC B60T 13/746; B60T 1/065; F16D 55/38; F16D 65/186; F16D 65/853; F16D 2121/24; F16D 2125/40

(57) ABSTRACT

The invention relates to a braking system of a motor vehicle that can be electrically driven by an electric machine, wherein the braking system comprises a multi-disc brake with a plurality of inner discs and a plurality of outer discs, which can be frictionally connected by means of a brake actuator, and the electric machine comprises a rotor which is torque-transmittingly coupled to at least one vehicle wheel of the motor vehicle, wherein the multi-disc brake is accommodated in a brake housing and the inner discs or the outer discs are torque-transmittingly connected to the rotor of the electric machine.

### CROSS-REFERENCE TO RELATED APPLICATION

The present application is the U.S. National Phase of PCT Patent Application Number PCT/DE2023/100832, filed on Nov. 8, 2023, which claims priority to German Patent Application Number 10 2022 131 384.0, filed Nov. 28, 2022, the entire disclosures of which are incorporated by reference herein.

### TECHNICAL FIELD

The present disclosure relates to a braking system of a motor vehicle that can be driven electrically by an electric machine, wherein the braking system comprises a multi-disc brake with a plurality of inner discs and a plurality of outer discs which can be frictionally connected by means of a brake actuator, and the electric machine comprises a rotor which is torque-transmittingly coupled to at least one vehicle wheel of the motor vehicle.

### BACKGROUND

Electric motors are increasingly being used to drive motor vehicles to create alternatives to internal combustion engines that require fossil fuels. Significant efforts have already been made to improve the suitability of electric drives for everyday use and also to be able to offer users the driving comfort which they are accustomed to. A detailed description of an electric drive can be found in an article in the magazine ATZ, volume 113, May 2011, pages 360-365 by Erik Schneider, Frank Fickl, Bernd Cebulski and Jens Liebold with the title: Hochintegrativ und Flexibel Elektrische Antriebseinheit für E-Fahrzeuge [Highly Integrative and Flexible Electric Drive Unit for E-Vehicles]. This article describes a drive unit for an axle of a vehicle, which comprises an electric motor arranged to be coaxial to a bevel gear differential.

Motor vehicles of this type having a hybridized or electrified drive train cannot only accelerate but also brake with the aid of an electric motor. During braking, the electric motor is operated as a generator and the recuperated energy is used to charge the battery, for example. For safety reasons, however, an additional mechanical braking device is still required. For drives close to the wheel, such as a wheel hub motor or an electric axle, this results in a more difficult installation space situation.

In particular, a vehicle with an electric wheel hub drive, what is termed a e-wheel drive, often uses brakes with discs to slow down the vehicle. However, disc brakes with floating calipers, disc brakes with fixed calipers, drum brakes, and multi-disc brakes are also known.

DE 10 2019 120 409 A1, for example, discloses a braking device for a wheel hub drive assembly in which the braking partners, which are fixed relative to the circumferential direction, have cooling channels. The axially movable brake partner is actuated via brake cylinders. The braking partner that moves in the circumferential direction is designed as a disc carrier.

There is also an increasing requirement to reduce or completely avoid the emissions of brake dust, which often occur as particulate matter.

### SUMMARY

It is therefore the object of the disclosure to provide an improved braking system with high braking torques and low brake dust emissions.

This object is achieved by a braking system of a motor vehicle that can be driven electrically by means of an electric machine, wherein the braking system comprises a multi-disc brake with a plurality of inner discs and a plurality of outer discs which can be frictionally connected by means of a brake actuator, and the electric machine comprises a rotor which is torque-transmittingly coupled to at least one vehicle wheel of the motor vehicle, wherein the multi-disc brake is accommodated in a brake housing and the inner discs or the outer discs are torque-transmittingly connected to the rotor of the electric machine.

This has the advantage that brake dust from the multi-disc brake can be kept within the brake housing, which contributes to a direct reduction in the environmental impact. A further advantage of the braking system according to the disclosure is that the unsprung mass on the vehicle wheel can be reduced. It is also possible to increase the steering angle of the corresponding vehicle wheels by eliminating a brake arranged on the vehicle wheel.

The braking system according to the disclosure has the function of braking a vehicle wheel of the motor vehicle to be braked by means of a frictional connection. In particular, the multi-disc brake can be designed based on the functional principle of a dry or wet multi-disc brake. The multi-disc brake is arranged at a distance from the vehicle wheels in the drive train of the motor vehicle. The multi-disc brake is preferably coupled to the rotor of an electric machine.

The function of a multi-disc brake is to create a releasable, friction-fit connection between a brake shaft and a connecting structure, which is usually arranged in a non-rotatable manner for this purpose, to support a braking torque. For this purpose, the alternately arranged inner discs and outer discs of the disc set can be brought into non-positive or frictional contact by means of axial displacement and compression via their respective friction linings by means of a coupling process, so that the inner discs are arranged to rotate in a frictionally engaged manner relative to the outer discs about the common axis of rotation of the corresponding disc set or are arranged in a rotationally fixed manner relative to each other in the case of complete frictional engagement. On the other hand, if the inner discs and outer discs are axially pushed away from each other by a disengagement process, there is no longer any non-positive contact between the inner discs and the outer discs so that they can rotate freely against each other and consequently no torque or braking torque is transmitted between the inner discs and the outer discs.

A multi-disc brake usually consists of at least two inner and/or two outer discs. The inner discs are preferably arranged non-rotatably on an inner multi-disc carrier and the outer discs are preferably arranged non-rotatably on an outer multi-disc carrier. The inner multi-disc carrier is preferably connected to a brake shaft and the outer multi-disc carrier is preferably non-rotatably connected to a connection structure or vice versa.

The inner discs and outer discs form the disc set of the multi-disc brake. In the disc set, a plurality of inner discs and outer discs are preferably arranged alternately in the axial direction. The torque or braking torque that can be transmitted by the multi-disc brake between the inner discs and outer discs can be adjusted by the number and design of the inner discs and outer discs.

The inner discs have the function of transmitting a torque from the outer discs to the inner multi-disc carrier, in particular in a non-positive or friction-fit manner. The inner discs can be designed as circular ring-shaped discs in particular. The inner discs can be non-rotatably connected to the inner multi-disc carrier of the multi-disc brake. It can also be provided that the inner discs are displaced in an axial direction relative to the inner multi-disc carrier, for example by means of a corresponding toothing, to create a frictional connection with the outer discs.

The outer discs have the function of transmitting a torque from the inner discs to the outer multi-disc carrier, in particular in a non-positive or friction-fit manner. The outer discs can be designed as circular ring-shaped discs in particular. The outer discs can be non-rotatably connected to the outer multi-disc carrier of the multi-disc clutch. It can also be provided that the outer discs are displaced in an axial direction relative to the outer multi-disc carrier, for example via a corresponding toothing, to create a frictional connection with the inner discs. The outer multi-disc carrier can be designed as an outer disc clutch basket, for example.

A disc set can be accommodated in one or more multi-disc carriers and, in particular, can also be guided for linear movement. For this purpose, the inner discs can be accommodated in an inner multi-disc carrier and the outer discs in an outer multi-disc carrier. To form a linearly displaceable offset of the inner discs relative to the outer discs (or vice versa), the inner discs can be connected to the inner multi-disc carrier via internal spline toothings and/or the outer discs can be torque-transmittingly connected to the outer multi-disc carrier via external spline toothings.

The multi-disc brake can preferably comprise a spring element. The spring element has the task of moving the inner discs and the outer discs into a predefined position in relation to each other using spring force. This predefined position usually corresponds to a “normally open” or “normally closed” operating state of the multi-disc brake, which means that when the brake actuator is not actuated, the inner discs and outer discs are either pressed against each other or released by the spring element.

A multi-disc brake can also have a shift piston. The shift piston has the function of converting the engagement or disengagement processes specified by the brake actuator into an axial displacement of the inner discs and/or the outer discs for the purpose of establishing a frictional connection when braking or releasing a frictional connection when releasing the multi-disc brake.

The multi-disc brake is preferably arranged in a brake housing. The brake housing encloses the multi-disc brake. A brake housing can also accommodate one or more brake actuators. The brake housing can furthermore be part of a cooling system for the electric machine, and can be designed in such a way that cooling fluid can be supplied to the braking system via the brake housing and/or the heat can be dissipated to the outside via the housing surfaces. The brake housing also protects the complementary brake from external mechanical and/or chemical influences. A brake housing can be formed in particular from a metallic material. Advantageously, the brake housing can be formed from a metallic cast material, such as gray cast iron or cast steel. In principle, it is also conceivable to form the brake housing entirely or partially from a plastic. Furthermore, it is possible for the brake housing to be designed in one piece or in several parts. The brake housing can also be designed completely or partially as part of a motor housing of an electric machine or a transmission housing of a transmission coupled to the electric machine. Preferably, the brake housing and the motor housing or the transmission housing form a single structural unit. For example, the brake housing can be bolted to the motor housing or the transmission housing. The brake housing is preferably designed in such a way that dust generated during braking cannot escape from the brake housing. This prevents unwanted pollution of the environment with brake dust. Braking noise can also be reduced by encapsulating the braking system in this way. Another advantageous aspect of this encapsulation is that the braking performance of the braking system is independent of the weather conditions outside the motor vehicle.

In particular, a brake actuator has the function of activating the brake, i.e., setting it to a friction-fit operating state and an operating state released from the frictional connection. In particular, the brake actuator can be actuated pneumatically, hydraulically, by an electric motor, mechanically, electromagnetically, or by any combination thereof. The brake actuator is preferably configured as an electromechanical brake actuator.

The braking system according to the disclosure is preferably provided for a motor vehicle which can be driven electrically by means of an electric machine. Electric machines within the meaning of this application are used to convert electrical energy into mechanical energy and/or vice versa, and usually comprise a stationary part referred to as a stator or stationary anchor, and a part referred to as a rotor or runner and arranged to be movable relative to the stationary part. In connection with the present disclosure, an electric machine can be designed in particular as a rotary machine. With such electric rotary machines, a distinction is made between radial flow machines and axial flow machines. A radial flow machine is characterized in that the magnetic field lines extend in the radial direction in the air gap formed between rotor and stator, while in the case of an axial flux machine the magnetic field lines extend in the axial direction in the air gap formed between rotor and stator. In the context of the present disclosure, an electric machine is intended in particular for use within a drive train of a hybrid or fully electrically powered motor vehicle. In particular, the electric machine is dimensioned such that vehicle speeds of more than 50 km/h, preferably more than 80 km/h, and in particular more than 100 km/h can be achieved. The electric machine particularly preferably has an output of more than 30 KW, preferably more than 50 KW and in particular more than 70 KW. Furthermore, it is preferred that the electric machine provides speeds greater than 5000 rpm, particularly preferably greater than 10,000 rpm, very particularly preferably greater than 12,500 rpm.

The electric machine can have a housing, also known as a motor housing. The motor housing encloses the electric machine. A motor housing can also accommodate the control and power electronics unit, and preferably also at least parts of the braking system. The motor housing can furthermore be part of a cooling system for the electric machine, and can be designed such that cooling fluid can be supplied to the electric machine via the motor housing and/or the heat can be dissipated to the outside via the motor housing surfaces. In addition, the motor housing protects the electric machine and any electronics that can be present from external influences. A motor housing of the electric machine can be formed in particular from a metallic material. Advantageously, the motor housing can be formed from a metallic cast material, such as gray cast iron or cast steel. In principle, it is also conceivable to form the motor housing entirely or partially from a plastic. Furthermore, it is possible for the motor housing of the electric machine to be designed in one piece or in several parts.

A rotor is the rotating (spinning) part of an electric machine. The rotor particularly comprises a rotor shaft and one or more rotor bodies formed of rotor lamination stacks which are non-rotatably arranged on the rotor body. The rotor shaft can be hollow, which firstly results in weight savings and secondly allows the supply of lubricant or coolant to the rotor body. In particular, the rotor shaft can be coupled to the brake shaft of the complementary brake.

The electric machine and/or the multi-disc brake can preferably be coupled to a transmission, which is designed in particular to generate a drive torque for the motor vehicle. The drive torque is particularly preferably a main drive torque, so that the motor vehicle is driven exclusively by the drive torque.

In particular, it can be provided that the electric machine and/or the multi-disc brake and the transmission are arranged in a common drive train housing. Alternatively, it would of course also be possible for the electric machine to have a motor housing and the transmission to have a transmission housing, wherein the structural unit can then be brought about by fixing the transmission assembly in relation to the electric machine. This structural unit is sometimes also referred to as an e-axle. The drive train housing is preferably formed from a metallic material, particularly preferably from aluminum, gray cast iron or cast steel, in particular by means of a primary shaping process such as casting or die-casting. In principle, however, it would also be possible to form the drive train housing from a plastic material. The drive train housing can particularly preferably have a cup-like basic shape, such that the electric machine and the transmission can be inserted into the drive train housing via the open end face thereof.

The electric machine preferably has a motor housing and/or the transmission has a transmission housing, wherein the structural unit can then be implemented by fixing the transmission in relation to the electric machine. The transmission housing is a housing for accommodating a transmission. It has the task of guiding existing shafts via the bearings and giving the wheels (cam discs, where applicable) the degrees of freedom they require under all loads without impeding their rotational and possible path movement, as well as absorbing bearing forces and supporting torques. A transmission housing can be designed as single-shell or multi-shell, i.e., undivided or divided. In particular, the transmission housing should be able to dampen noise and vibrations as well as safely absorb hydraulic fluid. The transmission housing is preferably formed from a metallic material, particularly preferably from aluminum, gray cast iron or cast steel, in particular by means of a primary shaping process such as casting or die-casting.

Furthermore, the transmission can preferably be configured as a planetary gear or comprise a planetary gear. The planetary gear can preferably have a sun gear and several planetary gears meshing with the sun gear and rotatably mounted in a planetary gear carrier, which rotate around the sun gear, as well as a ring gear arranged to be coaxial to the sun gear, in which the planetary gears roll.

Furthermore, the transmission can have a differential transmission. A differential transmission is a planetary gear with one drive and two outputs. It usually has the function of driving two vehicle wheels of a motor vehicle in such a way that they can turn at different speeds when cornering, but with the same propulsive force.

To realize different drive or operating modes for the motor vehicle, one or more separating clutches can be provided within the torque path between the electric machine and a vehicle wheel. A separating clutch can be arranged between the output of the electric machine and the input of the transmission, for example, so that the electric machine can be decoupled from the transmission, allowing the motor vehicle to be operated in coasting mode. It would also be conceivable to arrange a separating clutch between the output of the transmission and a vehicle wheel or the vehicle wheels, also allowing the motor vehicle to be operated in coasting mode. Finally, it is also possible to arrange a separating clutch between the input of the braking system and the output of the electric machine, which allows the braking system to be completely decoupled from the electric machine.

For the purposes of this application, motor vehicles are land vehicles that are moved by machine power without being bound to railroad tracks. A motor vehicle can be selected, for example, from the group of passenger cars, trucks, small motorcycles, light motor vehicles, motorcycles, motor buses/coaches or tractors.

Advantageous embodiments of the disclosure are specified in the dependent claims. The features listed individually in the dependent claims can be combined with one another in a technologically meaningful manner and can define further embodiments of the disclosure. In addition, the features indicated in the claims are specified and explained in more detail in the description, wherein further preferred embodiments of the disclosure are shown.

According to an advantageous embodiment of the disclosure, it can be provided that the brake actuator is an electromechanical brake actuator comprising an electric drive and a transmission. According to a further preferred further development of the disclosure, it can also be provided that the electric drive is designed as an electric motor. It is possible to design the electric motor as a linear drive or as a rotary drive.

Furthermore, according to an equally advantageous embodiment of the disclosure, it can be provided that the transmission comprises a spindle drive, in particular a ball screw drive, with a threaded spindle and a spindle nut, wherein the spindle nut is coupled to the inner discs or the outer discs in such a way that a rotation of the threaded spindle causes a translational displacement of the inner discs or the outer discs to produce or release a frictional connection. A spindle drive thus converts a rotary motion into a linear motion with the help of a threaded spindle and a spindle nut, which are coupled to each other in such a way that they convert a rotary motion of the threaded spindle or spindle nut into a linear movement of the threaded spindle or spindle nut. In its simplest form, a spindle drive can be formed from a threaded spindle and a spindle nut, wherein the thread of the threaded spindle meshes directly into a corresponding internal thread of the spindle nut, wherein a sliding friction occurs along the thread flanks that are in a meshing engagement with each other.

According to a further particularly preferred embodiment of the disclosure, it can be provided that the multi-disc brake is designed as a wet-running multi-disc brake. In particular, this makes it possible to cool the disc sets and dissipate heat from the multi-disc brake.

Furthermore, the disclosure can also have been further developed in such a way that the transmission of the brake actuator is arranged within the brake housing. In an equally preferred embodiment variant of the disclosure, it can also be provided that the electric drive is located outside the brake housing. This means that the electric drive can be arranged outside the wet chamber of the brake housing.

It can also be advantageous to further develop the disclosure in such a way that the spindle drive is arranged radially outside the outer discs of the multi-disc brake within the brake housing, which contributes to axially particularly compact multi-disc braking systems.

According to a further preferred embodiment of the object of the disclosure, it can be provided that the spindle nut is connected to an annular piston, which forms an annular contact surface with an axially outermost one of the inner discs or the outer discs. This ensures that the multi-disc brake can be activated without the risk of wedging.

Finally, the disclosure can also be advantageously designed in such a way that the inner discs are non-rotatably connected to an inner multi-disc carrier, which in turn is non-rotatably coupled to a brake shaft, which also contributes to a compact design. Preferably, the brake shaft can also have at least one fluid channel by means of which a hydraulic fluid can be fed into the interior of the brake housing.

The disclosure is explained in more detail below with reference to figures without limiting the general concept of the disclosure.

### BRIEF DESCRIPTION OF THE DRAWINGS

In the figures:

FIG. 1 shows a motor vehicle having an electric drive in a schematic block switch view,

FIG. 2 shows an axle drive train with a braking system in a schematic axial sectional view,

FIG. 3 shows a detailed view of a braking system in a schematic axial sectional view.

### DESCRIPTION OF EMBODIMENTS

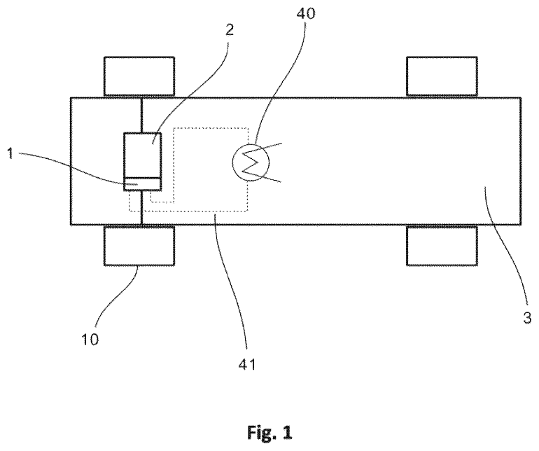

FIG. 1 shows a braking system 1 of a motor vehicle 3 that can be driven electrically by means of an electric machine 2.

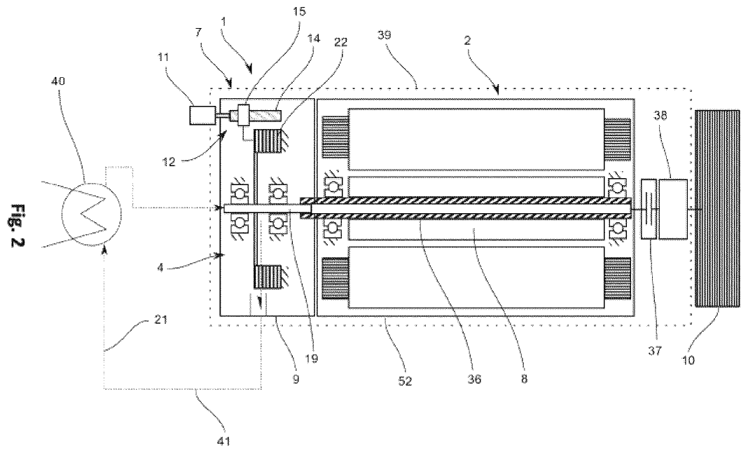

As can be seen in FIG. 2, the braking system 1 comprises a multi-disc brake 4 with a plurality of inner discs 5 and a plurality of outer discs 6, which can be frictionally connected by means of a brake actuator 7. The electric machine 2 of the axle drive train 39 has a rotor 8, which is torque-transmittingly coupled to at least one vehicle wheel 10 of the motor vehicle 3. A separating clutch 37 and a transmission assembly 38 are arranged in the torque flow between the electric machine 2 and the vehicle wheel 10. The separating clutch 37 allows the electric machine 2 to be disconnected from the drive path so that, for example, this can be used to set the motor vehicle to coasting mode.

The multi-disc brake 4 is accommodated in a brake housing 9 and the inner discs 5 or the outer discs 6 are torque-transmittingly connected to the rotor 8 of the electric machine 2.

In the design example shown, the brake actuator 7 is designed as an electromechanical brake actuator comprising an electric drive 11 and a transmission 12. The electric drive 11 is designed as an electric motor. The transmission 12 is configured as a spindle drive 13, with a threaded spindle 14 and a spindle nut 15, wherein the spindle nut 15 is coupled to the inner discs 5 or the outer discs 6 in such a way that a rotation of the threaded spindle 14 causes a translational displacement of the inner discs 5 or the outer discs 6 to produce or release a frictional connection. In the embodiment shown, the multi-disc brake 4 is designed as a wet-running multi-disc brake 4.

The spindle drive 13 of the brake actuator 7 is arranged within the brake housing 9, while the electric drive 11 is positioned outside the brake housing 9. The spindle drive 13 is arranged within the brake housing 9 radially outside the outer discs 6 of the multi-disc brake 4. The spindle nut 15 is connected to an annular piston 16, which forms an annular contact surface 17 with an axially outermost one of the inner discs 5 or the outer discs 6. The inner discs 5 are non-rotatably connected to an inner multi-disc carrier 18, which in turn is non-rotatably coupled to a brake shaft 19. The brake shaft 19 has a fluid channel 20, by means of which a hydraulic fluid 21 can be fed into the interior of the brake housing 9.

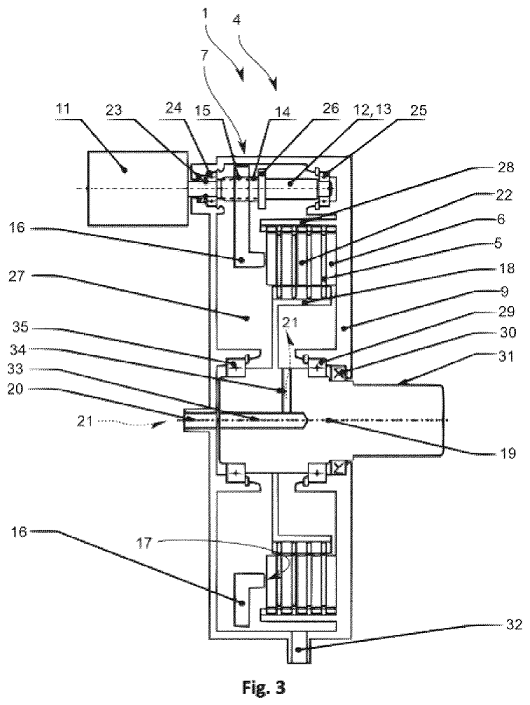

As can be clearly seen in FIG. 3, the disc set 22 is used to generate the braking torque. This consists of several axially displaceable outer discs 6 designed as steel discs and several axially displaceable inner discs 5 designed as friction discs. The outer discs 6 are rotationally secured by a corresponding geometry in the outer multi-disc carrier 28. The displacement range of the outer discs 6 is limited on the one hand by a fixed support geometry. This can be arranged in the brake housing 9, for example. On the other hand, the displacement range of the outer discs 6 is limited by the contact geometry, which is arranged on the annular piston 16. The annular piston 16 can be axially displaced by an arrangement described below.

The inner discs 5 are secured against rotation by a corresponding geometry arranged in the inner multi-disc carrier 18. The displacement range of the inner discs 5 is limited by the outer discs 6. In the non-actuated state, when no braking torque is to be generated, there is a gap between the individual inner discs 5 and the outer discs 6. The inner multi-disc carrier 18 is arranged on the brake shaft 19 in such a way that both the input torque and the input speed are transmitted. These are transmitted from the rotor shaft 36 to the brake shaft 19 via the connection geometry 31 arranged on the brake shaft 19.

The brake housing 9 is designed in such a way that one or more wet chambers 27 are created. These are flushed with hydraulic fluid 21 during operation. The hydraulic fluid 21 is fed into the concentric and axially extending channel section 33 arranged in the brake shaft 19 via the fluid channel 20 arranged concentrically to the brake shaft 19. From there, the hydraulic fluid 21 enters one or more radially extending channel sections 34, which distribute the hydraulic fluid 21 through the inner multi-disc carrier 18 to the disc set 22 and through the outer multi-disc carrier 28. During braking, the hydraulic fluid 21 absorbs the heat generated and the heated hydraulic fluid 21 is discharged via the outlet 32. The multi-disc brake 4 is connected to the brake cooling circuit 41, via which the heat is dissipated from the brake housing 9 and fed to a heat exchanger 40. The heat exchanger 40 can in turn be coupled with a thermal management system, within which the dissipated heat is then reused.

The brake shaft 19 is mounted in the brake housing 9 via the rolling bearings 29, 35. The radial sealing element 30, which is arranged between the brake housing 9 and the brake shaft 19, seals the wet chamber 27 from the environment.

The axial force to be applied to the disc set 22 to generate a braking torque is generated by means of an electric drive 11 and a transmission 12, which is connected to the electric drive 11 in such a way that torque and speed can be transmitted. The electric drive 11 is arranged outside the brake housing 9, the transmission 12 is arranged within the brake housing 9 and within the wet chamber 27. The transmission 12 is configured as a spindle drive 13, which has a threaded spindle 14, which is rotatably arranged in the brake housing 9 via the rolling bearings 24, 25. The threaded spindle 14 and the brake housing 9 are sealed against the environment by a radially acting sealing element 23, which is arranged in the wet chamber 27.

The threaded spindle 14 has an external thread that can be designed with a sawtooth, trapezoidal, or recirculating ball profile. The associated spindle nut 15 meshes with this external thread directly or via an intermediate component. This translates a rotation of the threaded spindle 14 into an axial displacement of the spindle nut 15. The range of movement of the spindle nut 15 can, for example, be limited on the one hand by the brake housing 9 and on the other hand by a stop geometry 26 arranged on the threaded spindle 14. This design converts the torque generated by the electric drive 11 into an axial force, which is introduced into the disc set 22 via the spindle nut 15 and the annular piston 16 connected thereto, resulting in the braking effect.

For example, the power consumed by the electric drive 11 can be used to control the movement range of the annular piston 16. The torque of the contact between the annular piston 16 and the disc set 22 on their contact surface 17 can be determined via their rise. Alternatively, conventional limit switches can be arranged. The annular piston 16 can, for example, be rotationally secured and axially guided via two or more columns and plain bearings, a toothing or several guide blocks running in housing grooves.

The disclosure is not limited to the embodiments shown in the figures. The above description is therefore not to be regarded as limiting, but rather as illustrative. The following claims are to be understood as meaning that a stated feature is present in at least one embodiment of the disclosure. This does not exclude the presence of further features. Where the claims and the above description define “first” and “second” features, this designation serves to distinguish between two features of the same type without defining an order of precedence.

### LIST OF REFERENCE SYMBOLS

1 Braking system
2 Electric machine
3 Motor vehicle
4 Multi-disc brake
5 Inner discs
6 Outer discs
7 Brake actuator
8 Rotor
9 Brake housing
10 Vehicle wheel
11 Drive
12 Transmission
13 Spindle drive
14 Threaded spindle
15 Spindle nut
16 Annular piston
17 Contact surface
18 Inner multi-disc carrier
19 Brake shaft
20 Fluid channel
21 Hydraulic fluid
22 Disc set
23 Sealing element
24 Rolling bearing
25 Rolling bearing
26 Stop geometry
27 Wet chamber
28 Outer multi-disc carrier
29 Rolling bearing
30 Sealing element
31 Connection geometry
32 Outlet
33 Channel section
34 Channel section
35 Rolling bearing
36 Rotor shaft
37 Separating clutch
38 Transmission assembly
39 Axle drive train
40 Heat exchanger
41 Brake cooling circuit

1. A braking system of a motor vehicle that can be driven electrically by an electric machine, wherein the braking system comprises:
a multi-disc brake with a plurality of inner discs and a plurality of outer discs, which can be frictionally connected by means of a brake actuator, and the electric machine comprises a rotor which is torque-transmittingly coupled to at least one vehicle wheel of the motor vehicle,
the multi-disc brake accommodated in a brake housing and the inner discs or the outer discs are torque-transmittingly connected to the rotor of the electric machine.

2. The braking system according to claim 1, wherein-the brake actuator comprises an electromechanical brake actuator comprising an electric drive and a transmission.

3. The braking system according to claim 2, wherein the electric drive comprises an electric motor.

4. The braking system according to claim 2, wherein-the transmission comprises a spindle drive with a threaded spindle and a spindle nut, wherein the spindle nut is coupled to the inner discs or the outer discs in such a way that a rotation of the threaded spindle causes a translational displacement of the inner discs or the outer discs to produce or release a frictional connection.

5. The braking system according claim 1, wherein the multi-disc brake is comprises a wet-running multi-disc brake.

6. The braking system according to claim 2, wherein the transmission of the brake actuator is arranged within the brake housing.

7. The braking system according to claim 2, wherein the electric drive is arranged outside the brake housing.

8. The braking system according to claim 4, wherein the spindle drive is arranged radially outside the outer discs of the multi-disc brake within the brake housing.

9. The braking system according to claim 4, wherein the spindle nut is connected to an annular piston, which forms an annular contact surface with an axially outermost one of the inner discs or the outer discs.

10. The braking system according to claim 1, wherein the inner discs are non-rotatably connected to an inner multi-disc carrier, wherein the inner multi-disc carrier is non-rotatably coupled to a brake shaft.

11. A braking system of a motor vehicle electrically drivable by an electric machine, wherein the braking system comprises:
a multi-disc brake with a plurality of inner discs and a plurality of outer discs;
a brake actuator configured to frictionally connect the plurality of inner discs and the plurality of outer discs, the brake actuator comprising an electromechanical brake actuator comprising an electric drive and a transmission; and
a brake housing, the multi-disc brake located in the brake housing and the inner discs or the outer discs are torque-transmittingly connected to a rotor of the electric machine, wherein the rotor is torque-transmittingly coupled to at least one vehicle wheel of the motor vehicle, the transmission of the brake actuator arranged within the brake housing, the electric drive arranged outside the brake housing.

12. The braking system according to claim 11, wherein the electric drive comprises an electric motor.

13. The braking system according to claim 11 wherein the transmission comprises a spindle drive with a threaded spindle and a spindle nut, wherein the spindle nut is coupled to the inner discs or the outer discs in such a way that a rotation of the threaded spindle causes a translational displacement of the inner discs or the outer discs to produce or release a frictional connection.

14. The braking system according to claim 11, wherein the multi-disc brake is comprises a wet-running multi-disc brake.

15. The braking system according to claim 13, wherein the spindle drive is arranged radially outside the outer discs of the multi-disc brake within the brake housing.

16. The braking system according to claim 13, wherein the spindle nut is connected to an annular piston, which forms an annular contact surface with an axially outermost one of the inner discs or the outer discs.

17. The braking system according to claim 11, wherein the inner discs are non-rotatably connected to an inner multi-disc carrier, wherein the inner multi-disc carrier is non-rotatably coupled to a brake shaft.

18. A motor vehicle comprising:
an electric machine comprising a rotor; and
a braking system, the braking system coupled to the rotor of the electric machine, the braking system comprising:
a multi-disc brake with a plurality of inner discs and a plurality of outer discs;
a brake actuator configured to frictionally connect the plurality of inner discs and the plurality of outer discs; and
a brake housing, the multi-disc brake located in the brake housing and the inner discs or the outer discs are torque-transmittingly connected to a rotor of the electric machine, the rotor is torque-transmittingly coupled to at least one vehicle wheel of the motor vehicle.

19. The motor vehicle according to claim 18, wherein the transmission comprises a spindle drive with a threaded spindle and a spindle nut, wherein the spindle nut is coupled to the inner discs or the outer discs in such a way that a rotation of the threaded spindle causes a translational displacement of the inner discs or the outer discs to produce or release a frictional connection.

20. The motor vehicle system according to claim 18, wherein the multi-disc brake is comprises a wet-running multi-disc brake.
